(19) United States
(12) Patent Application Publication
(10) Pub. No.: US 2026/0276021 A1
(43) Pub. Date: Sep. 17, 2026

(54) INTERLOCK-RING

(71) Applicant: SEEGER-ORBIS GmbH, Königstein (DE)

(72) Inventor: Jan Steiger, Essenheim (DE)

(73) Assignee: SEEGER-ORBIS GmbH, Königstein (DE)

(21) Appl. No.: 19/564,468

(22) Filed: Mar. 12, 2026

(30) Foreign Application Priority Data
Mar. 13, 2025 (EU) 25 163671.8

(51) Int. Cl. F16B 21/18

(52) U.S. Cl. CPC F16B 21/186

(57) ABSTRACT

The invention relates to an interlock ring for securing a component on a shaft, wherein the interlock ring has a first end and a second end, a gap is present between the first end and the second end, and the interlock ring includes at least one spring element.

### FIELD OF THE INVENTION

The invention relates to an interlock ring for securing a component on a shaft, a system comprising a component, a shaft, and an interlock ring according to the invention, and a method for securing a component on a shaft, using an interlock ring.

### PRIOR ART

Interlock rings for securing a component on a shaft are used to secure components on a rotating shaft. For this purpose, the interlock ring has a first end and a second end. A gap is present between the first end and the second end. The interlock ring may thus be bent open to increase the radius of the interlock ring.

To secure a component on the shaft, the interlock ring is situated in a groove in the shaft in front of the component, with one side of the component resting against a surface of the interlock ring. In addition, the diameter of the interlock ring is smaller than the diameter of the shaft, so that the interlock ring and thus the component rests firmly in the groove. In this way the component is secured on the shaft, even when the shaft is rotating. The advantage of the interlock ring is that it can be removed from the shaft for uninstalling the component.

Centrifugal forces act on the interlock ring with increasing rotational speed of the shaft, and thus also of the interlock ring. Bending of the interlock ring occurs at high rotational speeds, so that the diameter of the interlock ring becomes larger. Thus, the interlock ring no longer rests firmly in the groove and comes loose from the shaft. As a result, the component as well is no longer secured. Consequently, interlock rings often have only low rotational speed resistance, so that securing the component is ensured only up to a low rotational speed.

An approach for increasing the rotational speed resistance is known from U.S. 2022/0065280 A1. The retaining ring has two turns. The first turn has an elevation, while the second turn has an opening. The elevation of the first turn engages in the opening in the second turn. The opening is larger than the elevation, so that the elevation rests in the opening with a certain amount of play. The increase and decrease of the diameter of the retaining ring are limited by the play of the elevation in the opening.

However, a second turn is required for the approach proposed in U.S. 2022/0065280 A1, thus increasing the material costs. In addition, handling is made more difficult, since the retaining ring from U.S. 2022/0065280 A1 has no opening with which the retaining ring can be easily bent open. In addition, the rotational speed resistance is limited by the elevation, since the elevation can come loose from the opening in the second turn at excessively high rotational speeds.

Proceeding from this prior art, the object of the present invention is to propose an inexpensive interlock ring that ensures easy handling for installing and uninstalling the interlock ring, and at the same time, good securing at high rotational speeds.

### SUMMARY OF THE INVENTION

According to a first aspect of the invention, the above object is achieved by an interlock ring for securing a component on a shaft, wherein the interlock ring has a first end and a second end, a gap is present between the first end and the second end, and the interlock ring includes at least one spring element.

The interlock ring may thus be cost-efficient, since it requires less material and is easy to manufacture. Furthermore, the interlock ring is easy to handle, and at the same time ensures good securing at high rotational speeds.

The interlock ring may be made of a steel, in particular a spring steel or precious metal. For example, the interlock ring may have holes for a gripping tool. The holes for a gripping tool may preferably be situated at the first end and the second end. The interlock ring may in particular be a retaining ring.

The interlock ring may have an inner side. The inner side may be smooth. For example, the inner side may possibly have no thread. The interlock ring may have an outer side. The outer side may be smooth. For example, the outer side may possibly have no thread. The distance of the inner side from the outer side may be the width of the interlock ring.

The interlock ring may have a radial direction. For example, the radial direction may extend from the center of the interlock ring to the outer side of the interlock ring. For example, the radial direction may extend from the center to the outer side. The outer radius of the interlock ring may [be the distance] from the center to the outer edge along the radial direction. The outer diameter may [be the distance] from an outer edge, through the center, to the opposite outer edge. The interlock ring may have a rectangular cross section along the radial direction.

The interlock ring may have an axial direction. The axial direction may be perpendicular to the radial direction. The axial extension of the interlock ring in the axial direction may be the thickness of the interlock ring. The thickness may be smaller than the outer diameter. The thickness may correspond to at most 20% of the outer diameter. The thickness may, for example, be the extension in the axial direction. For example, the thickness may be the material thickness parallel to the axial axis. The thickness may in particular be the distance between two faces of the interlock ring that are spaced apart in the axial direction. The thickness may in particular not be determinable at the at least one spring element.

The interlock ring may be designed to secure the component on the shaft. For example, the interlock ring may thus prevent the component from coming loose from the shaft, even at high rotational speeds.

The first end and the second end may represent the spatial delimitation of the interlock ring. For example, the first end and the second end may be outer faces of the interlock ring which may delimit the interlock ring.

The gap is present between the first end and the second end. The gap may be a spatial extension between the first end and the second end. For example, the gap may be free of material. For example, there may possibly be no solid material, for example metal, in the gap. For example, there may possibly be only air between the first end and the second end.

The interlock ring may extend over an angle of less than 360° from the first end to the second end. The interlock ring may be an open circle. For example, the interlock ring may have a ring-shaped design except for an opening that interrupts it. The interlock ring may have only one turn with a gap. Above or below the interlock ring, there may possibly be no further material that is connected to the interlock ring.

The at least one spring element may deform under load. The at least one spring element may recover its original shape when the load is relieved. The at least one spring element may be elastically deformable under load. The at least one spring element may be a flat spring. The at least one spring element may swivel about an axis when under load. For example, the at least one spring element may swivel about an axis at a connected end when under load. The connected end of the at least one spring element may be connected to further parts of the interlock ring. Alternatively or additionally, the at least one spring element may, for example, swivel about an axis along the radial direction when under load.

According to one exemplary embodiment, the at least one spring element may have a protruding design.

The at least one spring element may thus be manufacturable in a particularly simple and cost-effective manner. In addition, the handling may be particularly easy.

The at least one spring element may protrude in the axial direction. The at least one spring element may extend, at least in part, in the axial direction. The at least one spring element may particularly preferably extend in both the axial direction and a circumferential direction. The circumferential direction may extend along the inner side. The circumferential direction may extend around the axial direction.

The at least one spring element may protrude, in particular at least in part, from a surface of the interlock ring in the axial direction. For example, a surface of the interlock ring may form a comparison plane, wherein the at least one spring element may have a design that protrudes from the comparison plane. The comparison plane may preferably correspond to a surface of the interlock ring, which may lie between the inner side and the outer side. The comparison plane may possibly extend only in the radial direction. For example, the comparison plane may possibly not encompass the at least one spring element.

For example, the at least one spring element may protrude from a surface of the interlock ring.

According to one exemplary embodiment, the at least one spring element may have a free end, wherein the free end of the at least one spring element may be the part of the at least one spring element that protrudes the farthest.

The at least one spring element may thus be manufactured particularly easily by punching and embossing, so that the interlock ring may be particularly cost-efficient.

The free end may be a spatial delimitation of the at least one spring element. The free end may possibly not be connected to any other parts of the interlock ring. The free end may, for example, be situated at the at least one spring element, opposite from the connected end. The at least one spring element may have an arch-shaped design. For example, the at least one spring element may have an arch-shaped design from the connected end to the free end. The at least one spring element, except for the connected end, may be separate from the interlock ring. The at least one spring element may, for example, be curved in the axial direction.

The spring element may be particularly efficient when the free end of the at least one spring element may be the part of the at least one spring element that protrudes the farthest.

From the connected end toward the free end, the at least one spring element may continually protrude increasingly farther.

According to one exemplary embodiment, the at least one spring element may extend in the circumferential direction at an angle to the circumferential direction.

It is thus possible for the interlock ring to be installed in a particularly simple manner and manufactured particularly cost-effectively.

The at least one spring element may extend in the circumferential direction at an angle to the circumferential direction that is greater than 0°, preferably greater than 0° to 30°, particularly preferably 2° to 25°. The at least one spring element may extend in the circumferential direction at an angle to the circumferential direction and to the axial direction. The at least one spring element may extend in the circumferential direction at an angle to the circumferential direction that is greater than 0°, preferably greater than 0° to 30°, particularly preferably 2° to 25°, and at an angle to the axial direction that is less than 90°, preferably 60° to less than 90°, particularly preferably 65° to less than 90°. For example, the at least one spring element may extend at an angle to the circumferential direction that is greater than 0°, preferably greater than 0° to 30°, particularly preferably 2° to 25°, and at an angle to the axial direction that is less than 90°, preferably 60° to less than 90°, particularly preferably 65° to less than 90°. For example, the at least one spring element may have a design that increasingly protrudes in the circumferential direction or opposite the circumferential direction. For example, the at least one spring element may extend partially in the circumferential direction and partially in the axial direction. For example, the at least one spring element may extend at an angle of at least 80° to 100°, preferably 85° to 95°, particularly preferably 90°, with respect to the radial direction. The extension of the at least one spring element may be from the connected end to the free end. For example, the midpoint of a plane of the at least one spring element parallel to the radial direction may change in the axial direction along the circumferential direction.

For example, the distance of the at least one spring element in the axial direction with respect to the comparison plane may increase in the circumferential direction or opposite the circumferential direction. For example, the distance of the at least one spring element in the axial direction with respect to the comparison plane may increase from the connected end to the free end in the circumferential direction or opposite the circumferential direction. For example, the position of the at least one spring element in the axial direction may change from the connected end toward the free end along the circumferential direction.

The at least one spring element extends from the connected end to the free end, at least in part, in the circumferential direction. It is thus possible for the interlock ring to be manufactured particularly easily and satisfactorily installed.

According to one exemplary embodiment, the free end of the at least one spring element may be rounded.

In this cost-efficient way, the risk of injury and of damage to the shaft or to the component may be prevented, so that handling may be facilitated.

According to one exemplary embodiment, the at least one spring element may be situated at the inner side of the interlock ring.

The spring element may thus be introduced particularly easily into the groove and beneath the component, so that handling may be facilitated. In addition, the interlock ring can ensure good securing at high rotational speeds.

The at least one spring element may form a portion of the inner side. The at least one spring element may extend from the inner side of the interlock ring in the direction of the outer side.

According to one exemplary embodiment, the at least one spring element may be situated at the outer side of the interlock ring.

The at least one spring element may form a portion of the outer side. The at least one spring element may extend from the outer side of the interlock ring in the direction of the inner side.

According to one exemplary embodiment, the inner side of the interlock ring may be circular, viewed in the axial direction.

It is thus possible for the interlock ring to be installed particularly satisfactorily on the shaft and also for the interlock ring to secure the component particularly well, since the interlock ring can rest particularly tightly on the shaft.

The inner side of the interlock ring may have a circular design, viewed in the axial direction, except for the interruption by the gap. For example, the width of the interlock ring may be constant in the circumferential direction. In particular, the width of the interlock ring in the radial direction may be constant. For example, the extension of the interlock ring in the radial direction may be constant. The spring element may be part of the outer side. The spring element may also be part of the inner side, wherein in particular the inner side may be circular. For example, the interlock ring may have a constant inner radius when the at least one spring element may lie in the plane of the comparison plane. The inner radius may be the distance from the center of the interlock ring to the inner side. Installation of the interlock ring may be simplified in this way.

For example, the at least one spring element may be curved in the circumferential direction, corresponding to the inner radius of the interlock ring. For example, the interlock ring may have a constant inner radius.

For example, the outer side of the interlock ring may be circular, viewed in the axial direction. For example, the interlock ring may have a constant outer radius.

For example, the inner side of the interlock ring and/or the outer side of the interlock ring may extend at an angle of 85° to 95°, preferably 90°, with respect to the radial direction. For example, the inner side of the interlock ring and/or the outer side of the interlock ring may extend at an angle of less than 5°, preferably less than 2°, particularly preferably 0°, with respect to the circumferential direction.

According to one exemplary embodiment, the at least one spring element may extend over 5° to 35°, preferably 10° to 30°, of the interlock ring.

The interlock ring can thus ensure particularly good securing at high rotational speeds.

The at least one spring element may extend over 5° to 35°, preferably 10° to 30°, of the interlock ring in the circumferential direction. The angle of 5° to 35°, preferably 10° to 30°, may correspond to the angle that may lie between a line going from the center to the free end and a further line going from the center to the connected end. The angle of 5° to 35°, preferably 10° to 30°, may correspond to the portion of the at least one spring element at the inner side when the inner side, including the gap, may correspond to 360°.

According to one exemplary embodiment, the at least one spring element may extend over 5% to 70%, preferably 20% to 60%, of the width.

The at least one spring element may thus be particularly stable, so that the at least one spring element and also the interlock ring can ensure good securing, even at high rotational speeds.

According to one exemplary embodiment, the interlock ring may have at least one recess for accommodating the at least one spring element.

The at least one spring element may thus be pressed in particularly easily under load, so that handling of the interlock ring may be facilitated.

The at least one recess may be situated between the inner side and the outer side. In particular, the at least one recess may extend, beginning from the inner side, to the outer side.

For accommodating the at least one spring element, the at least one recess may have the negative shape of the at least one spring element. The at least one spring element and the at least one recess may be designed in such a way that the at least one spring element is situated in the at least one recess under an in particular axial load. The at least one spring element and the at least one recess may be designed in such a way that the at least one spring element is situated in the at least one recess under an in particular axial force, so that the interlock ring may have a flat design. The at least one spring element and the at least one recess may be designed in such a way that the at least one spring element is situated in the at least one recess under an in particular axial force, so that the at least one spring element may be in flush alignment with the surface of the interlock ring in the axial direction.

The at least one recess may be created by bending out the at least one spring element.

According to one exemplary embodiment, the interlock ring may be monolithic.

The interlock ring may thus be manufactured in a particularly cost-effective manner. In addition, the interlock ring may possibly have no weak points in the form of connection points between two materials, so that the interlock ring can secure particularly well at high rotational speeds.

The entire interlock ring and thus also the at least one spring element may be made of the same material. The interlock ring may have a one-piece design The interlock ring may possibly have no joints.

According to one exemplary embodiment, the interlock ring may include at least two spring elements.

Particularly stable securing can thus be ensured at high rotational speeds.

The interlock ring may particularly preferably include at least four spring elements.

The at least two spring elements may have the same shape, thus facilitating handling.

According to one exemplary embodiment, the at least two spring elements may extend in different directions, viewed in the circumferential direction of the interlock ring.

The interlock ring can thus ensure stable securing, even at very high rotational speeds.

The extension of the at least two spring elements may be from the connected end to the open end. For example, for the at least two spring elements the connected ends may be situated facing one another. For example, for the at least two spring elements the free ends may be situated facing away from one another. For example, first the free end of the first of the two spring elements, then the connected end of the first of the two spring elements, then the connected end of the second of the two spring elements, and lastly the free end of the second of the two spring elements may be arranged in the circumferential direction.

The first of the at least two spring elements may extend in the clockwise direction from its connected end to the open end, while the second of the at least two spring elements may extend in the counterclockwise direction from its connected end to the open end.

The interlock ring may preferably have at least three spring elements, particularly preferably at least four spring elements, with the at least three spring elements extending in different directions in alternation, viewed in the circumferential direction of the interlock ring.

According to one exemplary embodiment, the at least two spring elements may be equidistantly situated in the circumferential direction of the interlock ring.

The force distribution in the interlock ring may thus be particularly uniform, so that the interlock ring can secure particularly well at high rotational speeds.

The at least two spring elements may be equidistantly situated in the circumferential direction of the interlock ring, for example, when the same angle may be present between the at least two spring elements. The angle between the at least two spring elements may be determined at the connected end, for example. Alternatively, the angle between the at least two spring elements may be determined, for example, at the end that is situated first in the clockwise direction, for example the free end or the connected end, of the at least two spring elements. In particular when the at least two spring elements extend in different directions, viewed in the circumferential direction of the interlock ring, for example the angle may be specified between the open end of the first of the at least two spring elements and the connected end of the second of the at least two spring elements. The angle may be particularly preferably specified between the midpoints of the at least two spring elements. For example, for two spring elements the midpoints of the two spring elements may each be 180° apart from one another. For example, for four spring elements the midpoints of the four spring elements may each be 90° apart from one another.

According to one exemplary embodiment, the interlock ring may be punched and embossed.

The interlock ring may thus be particularly simple and cost-efficient. In addition, the mechanical properties may be uniform over the entire interlock ring, so that the interlock ring can ensure good securing, even at high rotational speeds.

According to a second aspect of the invention, the above object is achieved by a system comprising a component, a shaft, and an interlock ring according to the invention, the shaft having a groove, the component having an opening, the shaft being situated inside the opening, the interlock ring being situated in the groove, and the interlock ring securing the component on the shaft,
a) wherein the at least one spring element is situated below the component and/or
b) wherein the shaft has at least one protrusion above the groove, and the at least one spring element is situated below the protrusion.

By use of the system, good securing can be ensured at high rotational speeds in a cost-effective manner. In addition, the system is easy to operate. Due to the arrangement of the at least one spring element below the component and/or the at least one protrusion, the centrifugal forces press on the interlock ring in such a way that the at least one spring element is pressed against the component and/or the at least one protrusion. Consequently, the centrifugal forces press the at least one spring element against the component and/or the at least one protrusion, so that the component and/or the at least one protrusion prevent(s) the at least one spring element, and thus also the interlock ring, from being expanded by the centrifugal forces. The component can thus be well secured by the interlock ring, even at high rotational speeds.

The shaft may be a rotating, in particular elongated, element. The shaft may have a circular cross section. The shaft may be designed to transmit rotational movements and/or torques.

The component may be a bearing, for example.

The groove may be an indentation for partially accommodating the interlock ring.

The opening may pass through the entire component. The opening may have a larger cross section than the shaft.

The interlock ring secures the component on the shaft. For example, the interlock ring may have an abutment surface, wherein the component may rest against the abutment surface, and the abutment surface may prevent movement of the component along the longitudinal axis of the shaft.

The at least one spring element may be situated radially below or radially within the component. For example, at least one spring element may be situated within the groove, and below or radially within the component. The component may be situated in part above the groove.

The at least one protrusion may be an extension of the shaft above the groove in the axial direction. The at least one protrusion may extend over 360°. Alternatively, the shaft may have multiple protrusions.

According to a third aspect of the invention, the above object is achieved by a method for securing a component on a shaft by use of an interlock ring according to the invention, wherein the component has an opening, and the shaft has a groove,
in which the shaft is situated in the opening,
in which the interlock ring is expanded,
in which the interlock ring is pressed against the component, so that the at least one spring element is pushed back opposite the elastic force,
in which the interlock ring is situated in the groove,
in which the at least one spring element springs back so that the at least one spring element is situated below the component.

By use of the method, good securing is ensured at high rotational speeds in a cost-effective manner. In addition, the method is easy to carry out.

To arrange the shaft in the opening, the shaft may be inserted into the opening and/or the opening may be pulled over the shaft.

The interlock ring may be expanded using pliers, for example. The expansion of the interlock ring may result in an increased diameter of the interlock ring.

The interlock ring is pressed against the component so that the at least one spring element is pushed back opposite the elastic force. For example, a load may be applied to the interlock ring until the interlock ring can form a flat surface.

According to a fourth aspect of the invention, the above object is achieved by use of an interlock ring according to the invention for securing a component on a shaft.

Further objects, features, advantages, and aspects of the present invention will become apparent to those skilled in the art from the following description and the appended claims. However, it should be understood that the following description, the appended claims, and the specific examples that describe preferred embodiments of the application are provided only for purposes of illustration. Various revisions and modifications within the spirit and the scope of the disclosed invention will be readily apparent to those skilled in the art when reading the following discussion.

### DEFINITIONS

In general, the following terms preferably have the meanings stated below, unless specified otherwise from the context in which they are used.

The term “include” used here, in addition to its literal meaning, encompasses the terms “essentially comprise” and “comprise,” and specifically refers to same. Thus, the term “include” refers to embodiments in which the subject matter, which “includes” the specifically stated elements, encompasses no further elements, as well as to embodiments in which the subject matter, which “includes” the specifically stated elements, may and/or in fact does encompass further elements. Likewise, the term “have” is to be understood as the term “include,” which also encompasses the terms “essentially comprise” and “comprise,” and refers to same. The term “essentially comprise,” to the extent possible, refers in particular to embodiments in which the subject matter, in addition to the specifically stated elements which essentially comprise the subject matter, encompasses 20% or fewer, in particular 15% or fewer, 10% or fewer, or in particular 5% or fewer, further elements.

### FIGURES

FIG. 1 shows an isometric illustration of an interlock ring;

FIG. 2 shows an isometric illustration of an interlock ring;

FIG. 3 shows a side illustration of an interlock ring;

FIG. 4 shows a cross section of an interlock ring;

FIG. 5 shows a view of an interlock ring along the axial direction;

FIG. 6 shows a cross section of a system; and

FIG. 7 shows a cross section of a system.

### DETAILED DESCRIPTION

FIG. 1 shows an isometric illustration of an interlock ring 2 for securing a component 4 on a shaft 6.

The interlock ring 2 has a first end 8 and a second end 10. A gap 12 is present between the first end 8 and the second end 10. The interlock ring 2 includes four spring elements 14.

The four spring elements 14 have a protruding design. The four spring elements 14 each have a free end 16. In addition, the four spring elements each have a connected end 15. The free ends 16 of the four spring elements 14 are the farthest protruding part of the four spring elements 14. The free ends 16 of the four spring elements 14 are rounded.

The four spring elements 14 are situated at the inner side 18 of the interlock ring 2. The interlock ring 2 also has an outer side 17. Alternatively and additionally, the spring elements 14 may be situated at the outer side 17 of the interlock ring 2.

The four spring elements 14 each extend over 10° to 30° of the interlock ring 2. In addition, the four spring elements 14 each extend over 20% to 60% of the radial width B. The interlock ring 2 has four recesses 20 for accommodating the four spring elements 14. The four recesses 20 are only partially visible in FIG. 1.

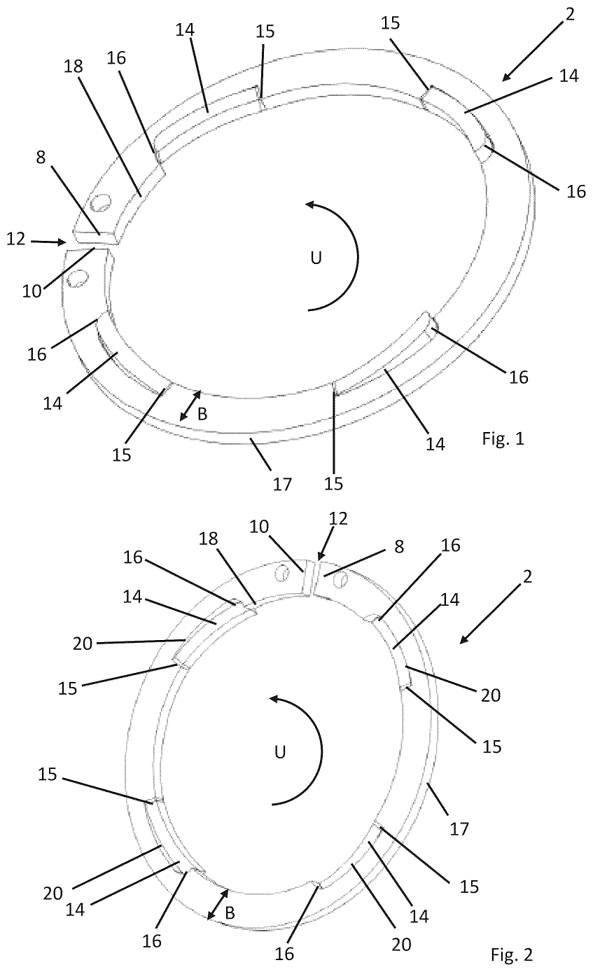

FIG. 2 shows an isometric illustration of an interlock ring for securing a component 4 on a shaft 6.

The interlock ring 2 has a first end 8 and a second end 10. A gap 12 is present between the first end 8 and the second end 10. The interlock ring 2 includes four spring elements 14.

The four spring elements 14 have a protruding design. The four spring elements 14 each have a free end 16. In addition, the four spring elements each have a connected end 15. The free ends 16 of the four spring elements 14 are the farthest protruding part of the four spring elements 14. The free ends 16 of the four spring elements 14 are rounded.

The four spring elements 14 are situated at the inner side 18 of the interlock ring 2. The interlock ring 2 also has an outer side 17. The spring elements 14 may also be situated at the outer side 17 of the interlock ring 2.

The four spring elements 14 each extend over 10° to 30° of the interlock ring 2. In addition, the four spring elements 14 each extend over 20% to 60% of the radial width B.

The interlock ring 2 has four recesses 20 for accommodating the four spring elements 14.

The interlock ring 2 shown in FIG. 1 and the interlock ring 2 shown in FIG. 2 are monolithic. In addition, in each case two of the four spring elements 14 extend in different directions, viewed in the circumferential direction U of the interlock ring 2. Thus, for example, the two spring elements 14 situated at the first end 8 and at the second end 10 extend in opposite directions.

The four spring elements 14 are equidistantly situated in the circumferential direction U of the interlock ring 2.

The interlock ring 2 is punched and embossed.

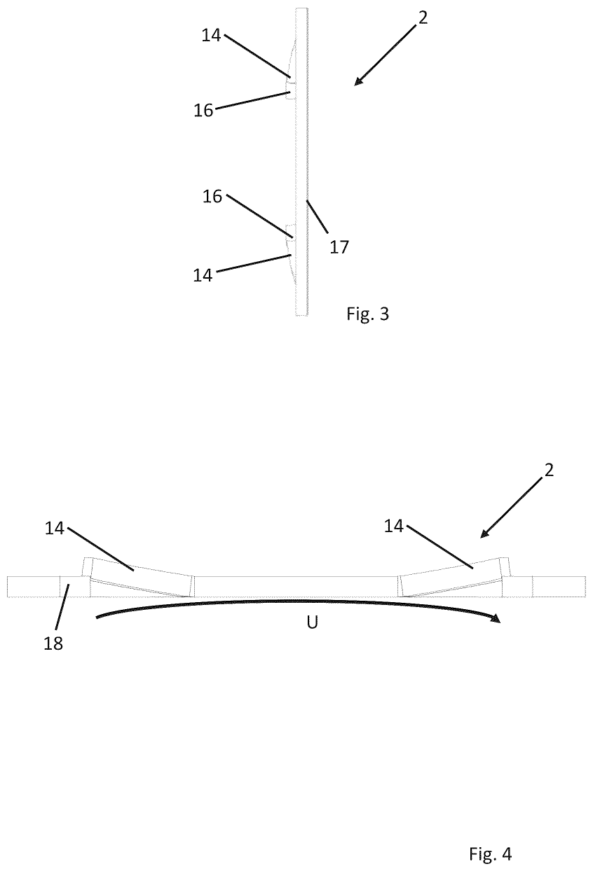

FIG. 3 shows a side illustration of an interlock ring 2 for securing a component 4 on a shaft 6.

The interlock ring 2 has a first end 8 and a second end 10. A gap 12 is present between the first end 8 and the second end 10. The interlock ring 2 includes four spring elements 14

The four spring elements 14 have a protruding design. The four spring elements 14 each have a free end 16. In addition, the four spring elements each have a connected end 15. The free ends 16 of the four spring elements 14 are the farthest protruding part of the four spring elements 14. The free ends 16 of the four spring elements 14 are rounded.

The four spring elements 14 are situated at the inner side 18 of the interlock ring 2. The interlock ring 2 also has an outer side 17. Alternatively and additionally, the four spring elements 14 may be situated at the outer side 17 of the interlock ring 2.

The four spring elements 14 each extend over 10° to 30° of the interlock ring 2. In addition, the four spring elements 14 each extend over 20% to 60% of the radial width B.

The interlock ring 2 has four recesses 20 for accommodating the four spring elements 14.

The interlock ring 2 is monolithic. In addition, in each case two of the four spring elements 14 extend in different directions, viewed in the circumferential direction U of the interlock ring 2. Thus, for example, the two spring elements 14 situated at the first end 8 and at the second end 10 extend in opposite directions.

The four spring elements 14 are equidistantly situated in the circumferential direction U of the interlock ring 2.

The interlock ring 2 is punched and embossed.

FIG. 4 shows a cross section of an interlock ring 2. The spring elements 14 extend in the circumferential direction U, at an angle to the circumferential direction U.

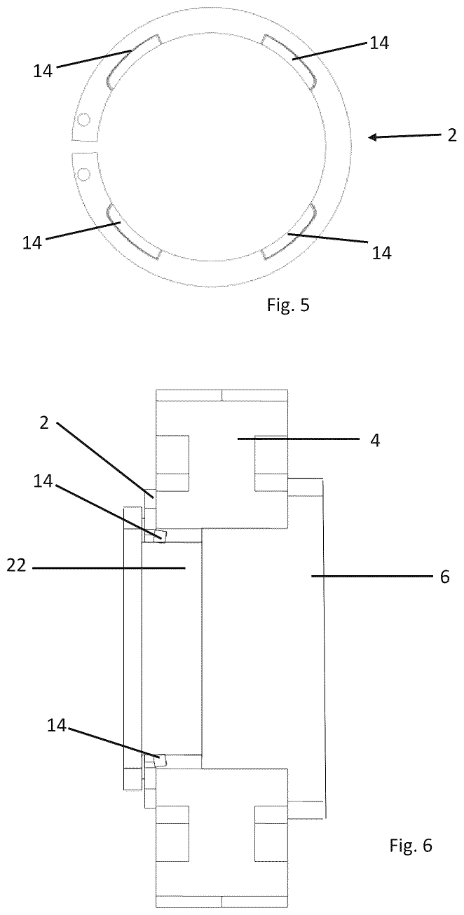

FIG. 5 shows a view of an interlock ring 2 along the axial direction A. The inner side 18 of the interlock ring 2 is circular, viewed in the axial direction A. The axial direction A projects from the page.

FIG. 6 shows a cross section of a system. The system comprises a component 4, a shaft 6, and an interlock ring 2. The shaft 6 has a groove 22. The component 4 has an opening 24. The shaft 6 is situated inside the opening 24. The interlock ring 2 is situated in the groove 22. The interlock ring 2 secures the component 4 on the shaft 6. The spring elements 14 are situated below the component 4.

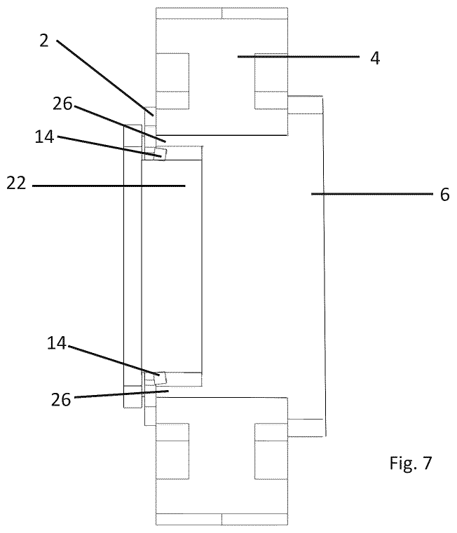

FIG. 7 shows a cross section of a system. The system comprises a component 4, a shaft 6, and an interlock ring 2. The shaft 6 has a groove 22. The component 4 has an opening 24. The shaft 6 is situated inside the opening 24. The interlock ring 2 is situated in the groove 22. The interlock ring 2 secures the component 4 on the shaft 6. The shaft 6 has a protrusion 26 above the groove 22, and the spring elements 14 are situated below the protrusion 26.

1. An interlock ring for securing a component on a shaft,
wherein the interlock ring has a first end and a second end,
wherein a gap is present between the first end and the second end,
wherein
the interlock ring includes at least one spring element.

2. The interlock ring according to claim 1,
wherein
the at least one spring element has a protruding design.

3. The interlock ring according to claim 1,
wherein
the at least one spring element has a free end,
wherein the free end of the at least one spring element is preferably the part of the at least one spring element that protrudes the farthest.

4. The interlock ring according to claim 1,
wherein
the at least one spring element extends in the circumferential direction (U) at an angle to the circumferential direction (U).

5. The interlock ring according to claim 1,
wherein
the interlock ring has an inner side and an outer side, wherein the at least one spring element is situated at the inner side of the interlock ring and/or the at least one spring element is situated at the outer side of the interlock ring.

6. The interlock ring according to claim 1,
wherein
the interlock ring has an inner side, wherein the inner side of the interlock ring is circular, viewed in the axial direction.

7. The interlock ring according to claim 1,
wherein
the interlock ring spans an overall angular range of 360° in the circumferential direction (U), wherein the at least one spring element extends over 5° to 35°, preferably 10° to 30°, of the interlock ring.

8. The interlock ring according to claim 1,
wherein
the interlock ring has a radial width (B), wherein the at least one spring element extends over 5% to 70%, preferably 20% to 60%, of the radial width (B).

9. The interlock ring according to claim 1,
wherein
the interlock ring has at least one recess for accommodating the at least one spring element.

10. The interlock ring according to claim 1,
wherein
the interlock ring includes at least two spring elements.

11. The interlock ring according to claim 10,
wherein
the at least two spring elements extend in different directions, viewed in the circumferential direction (U) of the interlock ring.

12. The interlock ring according to claim 10,
wherein
the at least two spring elements are equidistantly situated in the circumferential direction (U) of the interlock ring.

13. The interlock ring according to claim 1,
wherein
the interlock ring is punched and embossed.

14. A system comprising a component, a shaft, and an interlock ring according to claim 1,
wherein the shaft has a groove,
wherein the component has an opening,
wherein the shaft is situated inside the opening,
wherein the interlock ring is situated in the groove,
wherein the interlock ring secures the component on the shaft,
a) wherein the at least one spring element is situated below the component and/or
b) wherein the shaft has at least one protrusion above the groove, and
the at least one spring element is situated below the at least one protrusion.

15. A method for securing a component on a shaft by use of an interlock ring according to claim 1,
wherein the component has an opening,
wherein the shaft has a groove,
in which the shaft is situated in the opening,
in which the interlock ring is expanded,
in which the interlock ring is pressed against the component, so that the at least one spring element is pushed back opposite the elastic force,
in which the interlock ring is situated in the groove,
in which the at least one spring element springs back so that the at least one spring element is situated below the component.
